(19) United States
(12) Patent Application Publication
(10) Pub. No.: US 2004/0153208 A1
(43) Pub. Date: Aug. 5, 2004

(54) Method for sorting flat mail items in delivery sequence order

(76) Inventor: Wolf-Stephan Wilke, Konstanz (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/613,013

(22) Filed: Jul. 7, 2003

(30) Foreign Application Priority Data
Jan. 31, 2003 (DE) 10 303 976. 7

(51) Int. Cl. G06F 7/00

(52) U.S. Cl. 700/224

(57) ABSTRACT

In a first sorting machine the mail items are sorted into groups of associated delivery points. The mail items are ten fed group by group to a second sorting machine for the last sort pass in which the mail items of eh group are sorted to the delivery points of the relevant group, the mail items of a delivery point being conveyed into one, or if the mail volume is too great, into a plurality of adjacent, automatically estimable end points. As soon as all de mail items are in the end point(s), they are automatically unloaded onto an idle sectional conveyor in such a way that the mail items of an end point are in one section When all the mail items of the group have been loaded into the sections of the sectional conveyor, the sectional conveyor transports the mail items to a distribution unit in which the mail items of each section are mechanically combined and collected in delivery sequence order.

The present application claims priority to German Patent Application DE 103 03 976.7, filed Jan. 31, 2003, which is herein incorporated by reference.

### BACKGROUND OF THE INVASION

The present invention relates to a method for sorting items, such as flat mail items, in a delivery sequence order. The present invention will be discussed with respect to the sorting of mail items. The delivery sequence order refers to the order of mail delivery. In the case of mail items, this delivery order would be dictated by the route of the postal carrier. Several methods are known in the are for sorting mail items in a particular delivery order.

European reverence BP 0948416B1 discloses a Radix sorting method which makes use of several sorting passes of mail items through a sorting machine. Herein, there exists fewer sorting end points than mail item delivery stops. Accordingly, the mail items are fed and sequentially re-fed into a sorting machine. The order of the mail items improves with each pass through the sorting machine until a desired order is attained. With such solutions, mail items are automatically removed from the sorting end point in a complete stack and referred to the material input except for the last sorting pass (see EP 0 870 552 A3). There is no simple way of subdividing the mail items for the individual delivery stops by means of bundling or packing, If separator cards are used for differentiation, the carrier still has to do a considerable amount of fingering and merging as well as additional handling of the separator cards.

U.S. Pat. No. 5,977,501 discloses another delivery sorting scheme wherein the sorting machine maintains at least one end point for each delivery stop. Given a high number of delivery stops, this sorting machine become quite large, complex and expensive. Additionally, quite abit of storage space would be needed.

DE 196 36 980 A1 describes a system of cross-tying a stack of mail items and EP 0 303 203 A2 discloses how mail items (e.g. magazines) can be wrapped in transparent film.

A need exists in the art for a sorting machine which can son mail items by destination stop, in a predetermined sequence matching a predetermined delivery route, and in a cost effective and efficient manner. An additional consideration is space usage and manual intervention, both of which should be kept to a minimum

### SUMMARY OF THE MENTION

The present invention relates to a method for sorting items, such as mail items, wherein the mail its are subjected to several passes and sorting prior to being released for delivery. The present method also makes singling and wrapping of mail items or groups of mail items possible. The present method minimizes use of space and manual intervention.

The present method relates to two sorting machines or sorting machine sections acting in concert. Initially, the destination address of the mail items is determined. Then, in a first sorting machine, the mail items are sorted into first groups of associated delivery points in at least one sorting pass. The delivery points relate to the destination addresses. The mail items are then fed first group by first group to a second sorting machine for the last sorting pass in which the mail items of each first group are sorted into second groups, In the second groups, the nail items are sorted by delivery points of the group in question according to a relevant sorting plan as well as the known destination addresses. The mail items of a delivery point are sequentially directed into one, or if the mail volume is too great, into a plurality of adjacent, end points. The end points may be automatically estimable. As soon as all mail items assigned to a delivery point are in the end point(s), the mail items are automatically unloaded from the end point(s) onto an idle sectional conveyor in such a way that the mail items of an end point are in one section. When all the mail items of the group have been loaded into the sections of the sectional conveyor, the sectional conveyor transports the mail items to a distribution unit in which the mail items of each section are medically combined and collected in delivery sequence order.

The present method is particularly applicable to mail items having a limited or minimum stiffness. Likewise, another embodiment of the present method includes the steps of bundling, tying and/or wrapping grouped mail items for delivery. The bundling, tying and/or wrapping can be effected manually or automatically, with at least the latter combined with other mechanical functionality.

In still another embodiment, machine readable codes are applied to mail items, either at or upstream of the first sorting machine. The codes facilitate machine reading at the second sorting machine, The codes may comprise bar codes and the like. When used, it is necessary only that the codes themselves, rather then the complete address be read and decoded at the second sorting machine.

If the destination addresses are not yet known at the time when the machine-readable codes are applied to the mail items, in another embodiment, the identifiers for the mail items may be applied to the mail items as machine-readable codes, with the number range of the identifiers comprising at least the number of mail items sorted into groups by the first sorting machine. This code is then read in the second sorting machine and the destination address is determined for each mail item using a database in which the known destination addresses are stored in association with the identifiers.

In order to save on printing the ID codes onto the mail items, additional distinguishing identification features of the mail items may be detected. The detection could occur at or upstream from the first sorting machine. The features may then be stored in data records of an address database, the data records associated with particular mail items. These features may then be detected in and/or by the second sorting machine. The address database it then searched on the basis of the detected features and sorting information for the second sorting machine so obtained, If sorting-machine-incompatible mail items are also to be included, it is advantageous to transport them automatically to the sectional conveyor sections assigned to the relevant destination addresses preceding the distribution unit. Likewise, unaddressed mail items, such as advertising literature, which is to be delivered to all households can likewise be transported to the sections of the sectional conveyors preceding the distribution unit. The present method further comprises a method for sorting a plurality of mail items, comprising the steps of: determining destination addresses of mail items, sorting said mail items into delivery point groups, said delivery point groups comprising a plurality of said destination addresses, said step of sorting occurring at a first sorting machine, sorting into end points mail items in said delivery point groups, said mail items being sorted by a delivery sequence of said mail items to said destination addresses, wherein each of said end points is associated with at least one destination address, conveying said mail items from said each of said end points to corresponding sections of a sectioned conveyor belt;

conveying said mail items to a distribution unit, said mail items arriving in an order of said sections; and combining said mail items at said distribution unit in said order of said sections.

The present invention further comprises an apparats for performing the above method, the apparatus including: means for determining destination addresses of mail items, means for sorting said mail items into delivery point groups, said delivery point groups comprising a plurality of said destination addresses, said step of sorting occurring at a first sorting machine, means for sorting into end points mail items in said delivery point groups, said mail items being sorted by a delivery sequence of said mail items to said destination addresses, wherein each of said end points is associated with at least one destination address, means for conveying said mail items from said each of said end points to corresponding sections of a sectioned conveyor belt; means for conveying said mail items to a distribution unit, said mail items arriving in an order of said sections; and means for combining said mail items at said distribution unit in said order of said sections.

The invention firer still comprises an apparatus for sorting mail items, comprising a destination address reader, a first sorter for sorting said mail items according to said destination address, a second sorter for sorting said mail items according to a destination address delivery scheme, and a conveyor for conveying mail items sorted by delivery scheme to a distribution unit.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a general sequence of sorting according to the present method;

FIG. 2 depicts a time sequence of the present method;

FIG. 3 depicts a perspective view of two sorters for implementing the present method;

FIGS. 4a depicts lateral cross-sections through a full stacking tray, and

FIG. 4b depicts lateral cross-sections through an empty stacking tray.

### DETAILED DESCRIPTION OF THE INVENTION

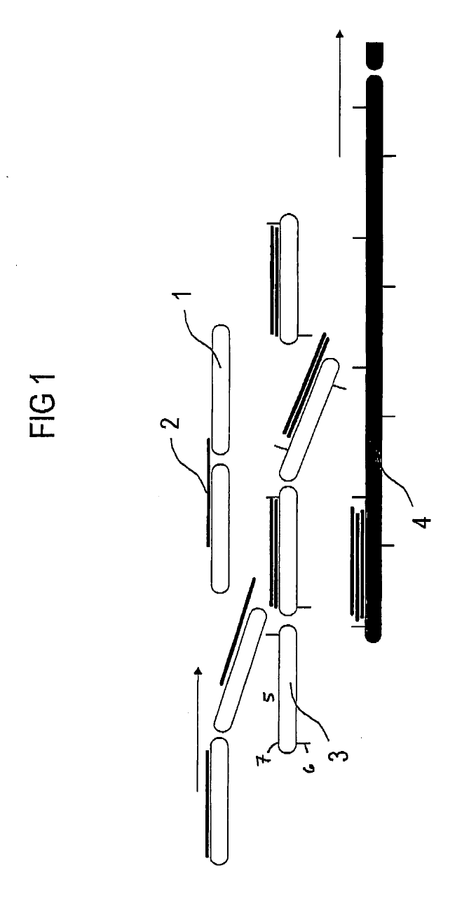

Referring to FIG. 1, mail items for a specific delivery zone are first sorted into first groups based upon delivery points. The sorting occurs in a known manner. The first groups are then sorted by individual delivery points in a second sorter. The second sorter may use a belt sorter as shown in the figure. Each mail item group includes mail items for up to as many delivery points as there are end points in the second sorter.

In operation, mail items of a first grouping are singled out and read for a destination address. Upon reading, the mail items are fed to a sorting section. The sorting section may comprise cascaded transfer modules 1. Upon modules 1, mail items 2 may be transported in flat position The modules 1 may be pivoted downward so as to direct the transported mail items to a select end point 5. Each end point 5 may also comprise a downwardly pivotable transfer module 3. The module 3 may also comprise a continuous conveying belt 7, divided by driver pins or walls 6. By way of design choice, conveyor belt 7 may comprise two driver pins. The belt transport action may act in concert with the pivoting action so as to Per convey one or a group of mail items, in a controlled manner, and in a downward direction.

Under typical operation conditions, the transfer module 3 is in a horizontal position and the conveying belt is idle. At a back end of the belt, in the direction of conveyance, a driver pin 6 may be disposed. The back driver pin may act as a stop upon which mail item(s) come to rest, The driver pin may also be located in front of the mil group such that the other driver pin comes around, during conveyance, and facilitates transport or helps push the mail item(s) downward when the transfer module 3 is pivoted.

If a particular transfer module I in a sorting section containing a mail item 2 pivots downwards as shown, this mail item 2 is transported obliquely from the top left hand portion of fig=re 1 onto the end point and is braked on the driving pin.

Each end point is assigned to a delivery point in such a way that the mail items are in delivery sequence order in adjacent end points. If all the relevant mail items 2 for a relevant end point have been sorted and positioned at the end point, the mail items are transported to a section of an idle sectional conveyor 4 disposed below the end points. The transport or transfer of mail items from end point 5 to idle sectional conveyor ⁴ may occur by the downward pivoting of the transfer module 3 of end point 5. Rather than idle, the conveying belt may also be set in motion. If all the mail items 2 of a mail item group are on the sectional conveyor 4, the drive of the sectional conveyor 4 is switched on and the mail items 2 are conveyed in delivery sequence order to a distribution Unit (not shown) where the mail items 2 may be mechanically combined for a particular delivery point. The combining may be effected by bundling or (film) wrapping the groups, packing the groups in bags and/or stowing the groups in containers.

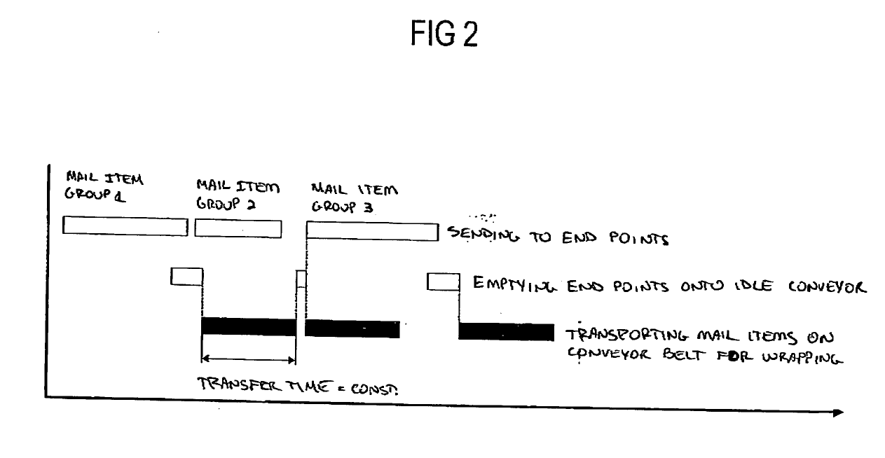

FIG. 2 depicts a time sequence which may be used by the present method. Initially, mail item group 1, for the first group of delivery points, is sorted by corresponding end points, Those end points into which all the assigned mail items have already been sorted away are emptied onto the idle sectional conveyor even before the sorting sequence for this mail item group 1 has un its course. Immediately after completion of sorting of the mail item group 1, the sorting of mail item group 2 commences, This takes place before each end point has been emptied, involving at least the steps of singling, reading, and conveying to the sorting section. As soon as all the mail items of mail item group I are on the sectional conveyor, the conveyor is set in motion and, after transfer time, all the mail items are in e distribution unit, the sectional conveyor is stopped, and only then can the end points for the mail item group 2 begin to be emptied When group 2 is completed, the sorting of the mail item group 3 begins. The process continues, sequentially until all the groups have been completed.

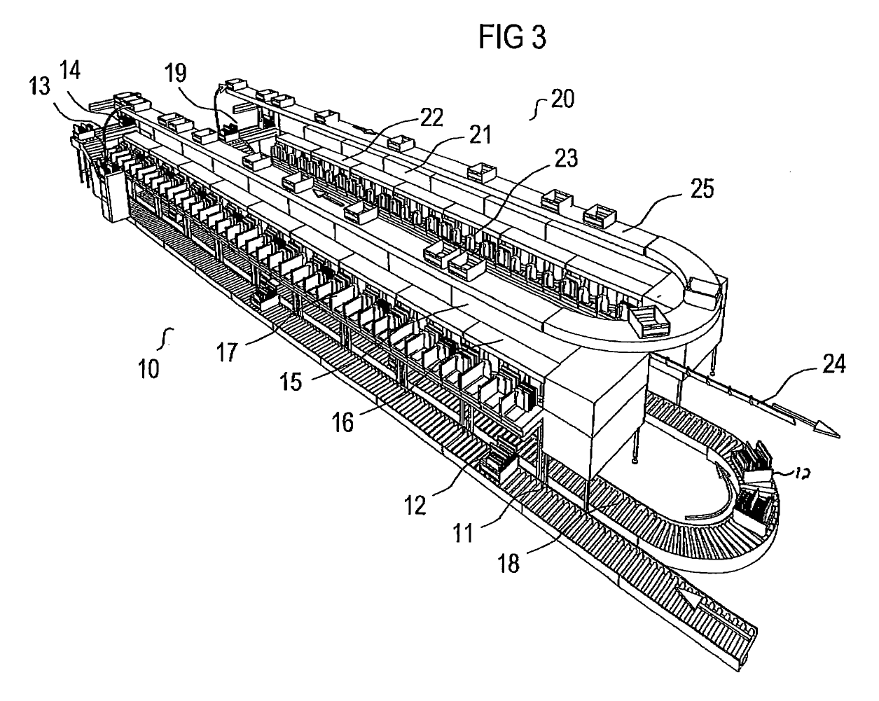

FIG. 3 depicts two sorting machines operating in concert. The transportation occurs in two sorting passes using two cascaded sorters in which the mail items are fed to the end points via sorting gates. Mail containers 12, with mail items for a delivery zone, are fed, via a roller conveyor track 1, to the input portion of first sorter 10. The first sorter 10 includes a feeder bed 13 and a sorting device 14. At the input portion, the containers 12 are unloaded and the mail items are placed on the feeder bed 13 in an upright position The mail item stack is then gradually pushed to the singling device 14 where the front most mil item is singled out Subsequent mail items are singled out in sequence, Each singled out mail item is aligned and its destination address read. Afterwards, the singled out mail items are fed via a letter run 15 to sorting section 16. At sorting section 16, the mail items are sorted via gates controlled in accordance with the read destination address, into adjacent stacking trays 17, the trays service as end points. Each stacking tray 17 is assigned to a specific group of delivery points. If all the mail items for the current zone have been sorted, the stacking trays 17 are emptied into containers 12. The containers 12 are then transported via another roller conveyor 18 to the it portion 19 of the second sorter 20. In the second sorter 20, the mail items are again subjected to a letter ran 21, Per the letter nm 21, the mail items are sorted to individual delivery points in a delivery sequence order. The sorting takes place in sorting section 22. The serially adjacent stacking trays 23 serve as end points and are assigned to the delivery points in delivery sequence order. The emptied mail containers 12 we fed, via an upper conveyor track 25, to the first sorter 10 in order to load in the sorted mail item groups from its stacking trays 17. As each delivery point is assigned a stacking tray 23, and the mail volume to be handled by each stacking tray 23 is limited to the size of the tray 23, The capacity of tray 23 is typically 40-50 min length.

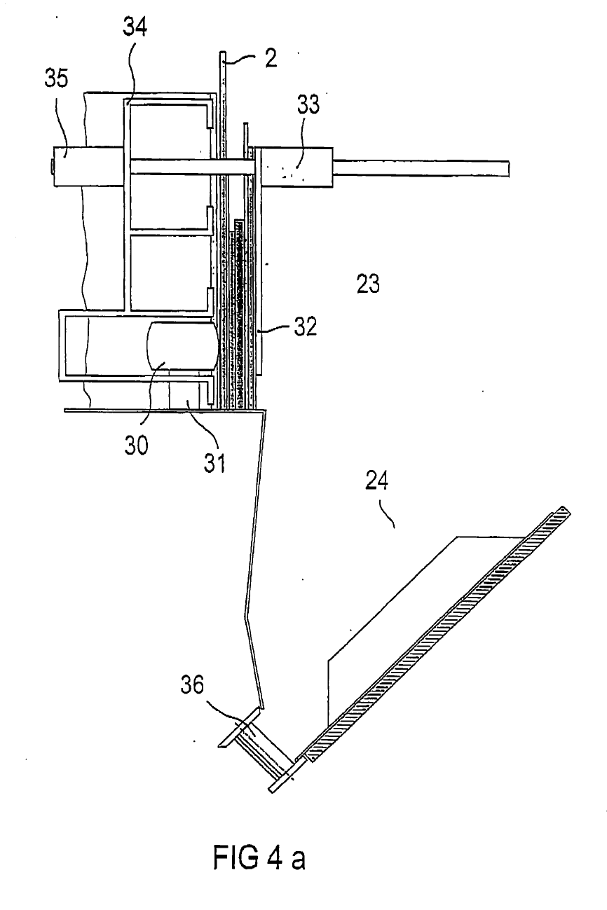

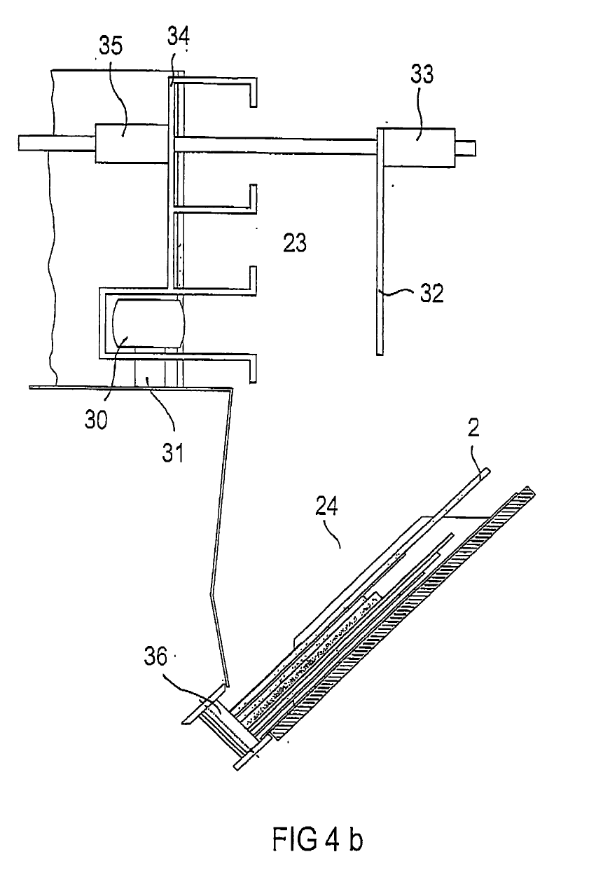

FIGS. 4a and 4b illustrate the emptying of the stacking trays 23 onto sectioned conveyor 24. The mail items in trays 23 are accommodated in an upright position As can be seen, the mail items 2 are conveyed sideways into th stacking tray 23. The stacking tray 23 serves as an end point using a stacking roller 30 at the stacking location as a deflector wall (not shown). The mail items are held in the upright position on the stacking base 31 by a driven stack support 32. As the stack thickness increases, the stack support 32 moves away from the stacking location according to the measured mail thickness (driven by a drive 33) or according to a certain stack pressure to be maintained against the stack via a song resilience (not shown) (max. travel tray depth). If all of the provided mail items 2 are in the stacking tray 23 and/or the tray is filled up, it becomes necessary empty the stacking tray 23 into the sectioned conveyor 24. The emptying is effected by the cooperation of the pushing unit 34 and support 32. Both elements act in concert moving in a direction towards the right of the figure. With the movement, the mail items 2 are displaced towards the right. The movement may be rapid. Lacking bottom support the mail items drop into a section of sectional conveyor 24. The relatively rapid motion of the stack support 32 and of the pusher unit 34 is generated by appropriate drives 33 and 35, the stack support 32 covering a comparatively large distance and thereby preventing the stack from jamming. The drives 33 and 35 can be implemented in a known manner, e.g. as a linear drive or as a rack-and-pinion drive. The pusher 34 unit is implemented such that a force can be applied as evenly as possible to the surface of the mail items, Due to the rapid motion and the resulting abrupt application of force to the stack the latter is pushed over the edge of the short tray base 31 without significant deformation due to the force of inertia. As jamming of the stack is eliminated, the stack drops, as the result of gravity, onto the idle sectional conveyor 24, located outside the stacking trays 23, below the stacking bases 31, and inclined from the vertical in the unloading direction for transporting the mail stack in the sections to the distribution unit. To ensure that the mail items do not slip down from the sectional conveyor 24, at its lower lateral boundary a narrow roller track 36 inclined at an angle of approximately 90° is disposed on which the mail items 2 are supported with their narrow sides. As soon as all the stacking trays 23 have been emptied, the sectional conveyor 24 is set in motion until all the mail stacks have been transferred to the distribution unit.

FIG. 4b depicts the now fallen mail items staked in sectional conveyor 24. As shown, the mail items are in the same substantial order as when in stacking tray 23.

The invention being thus described, it will be obvious that the same may be varied in many ways. The variations are not to be regarded as a departure from the spirit and scope of the invention, and al such modifications as would be obvious to one skilled in the art are intended to be inluded within the scope of the following clay.

I claim:

1. A method for sorting a plurality of mail items, comprising the steps of:
determining destination addresses of mail items;
sorting said mail items into delivery point groups, each of said delivery point groups comprising a plurality of said destination addresses, said step of sorting occurring at a first sorting machine;
sorting into end points mail items of said delivery point groups, said mail items being sorted by a destination address delivery sequence of said mail items, whereby each of said end points is associated with at least one destination address, and said step of sorting into end points occurs at a second sorting machine;
conveying said mail items from said each of said end points to corresponding sections of a sectioned conveyor belt;
conveying said mail items to a distribution unit with said conveyor belt, said mail items arriving in an order of said sections; and
combining said mail items at said distribution unit in said order of said sections.

2. The method according to claim 1, wherein if an end point if filled, an adjacent end point is used to accommodate mail items of a same destination address.

3. The method according to claim 1, wherein said step of combining further comprises the step of bundling said mail items.

4. The method according to claim 3, wherein said binding is performed with a tying device.

5. The method according to claim 1, wherein said step of combining further comprises the step of wrapping said mail items.

6. The method according to claim 1, finer comprising the step of applying machine readable code to said mail items.

7. The method according to claim 6, wherein said step of applying machine readable code occurs at said first sorter machine.

8. The method according to claim 6, wherein said stop of applying occurs upstream of said first sorter machine.

9. The method according to claim 6, Her comprising the step of reading said machine readable code at said second sorter machine.

10. The method according to claim 6, wherein said machine readable code comprises a bar code.

11. The method according to claim 6, wherein said machine code comprises an identifier identifying at least a number of mail items sorted into at least one group at said first sorter.

12. The method according to claim 11, wherein said identifier fir relates to a destination address stored in data records of a database, said data records associated with said identifier such that a destination address of a mail item can be obtained from said database using said identifier to locate an appropriate data record.

13. The method according to claim 12, further comprising the steps of:
reading said machine readable code at said second sorter machine,
querying said database for a destination address associated with said machine readable code,
retrieving said destination address from said database, and
determining an end point for a mail item based upon said retrieved destination address, and
sorting said mail item to said end point.

14. The method according to claim 1, further comprising the steps of:
storing destination addresses in data records of a database,
associating distinguishing features of mail items with said data records comprising destination addresses of said mail items, and
wherein said step of sorting into end points further comprises the steps of:
determining said distinguishing features,
querying said database for data records matching said distinguishing features,
retrieving destination addresses from said data records from said database, said data records associated with said distinguishing features, and
sorting mail items according to said retrieved destination addresses.

15. The method according to claim 14, wherein said step of sorting mail items according to said retrieved destination addresses occurs at said second sorter machine.

16. The method according to claim 1, further comprising the steps of;
reading destination addresses of sorting machine incompatible mail items;
transferring sorting machine incompatible mail items into sections associated with destination addresses of said incompatible mail items prior to said step of conveying said mail items to a distribution unit

17. The method according to claim 16, wherein said step of reading destination addresses of sorting machine incompatible mail items and transferring sorting machine incompatible mail items is performed automatically.

18. The method according to claim 1, further comprising the steps of transferring unaddressed mail items into sections associated with unaddressed mail items prior to said step of conveying said mail items to a distribution unit.

19. The method according to claim 18, wherein said step of transferring unaddressed mail items is performed automatically.

20. An apparats method for sorting a plurality of mail items, comprising:
means for determining destination addresses of mail items,
mums for sorting said mail items into delivery point groups, said delivery point groups comprising a plurality of said destination addresses, said step of sorting occurring at a first sorting machine,
means for sorting into end points mail items in said delivery point groups, said mail items being sorted by a delivery sequence of said mail items to said destination addresses, when each of said end points is associated with at least one destination address,
means for conveying said mail items from said each of said end points to corresponding sections of a sectioned conveyor belt;
means for conveying said mail items to a distribution unit, said mail items arriving in an order of said sections; and
means for combining said mail items at said distribution unit in said order of said sections.

21. The apparatus according to claim 20, wherein said means for combing further comprises means for bundling said mail items.

22. The apparatus according to claim 21, wherein said means for bundling is a tying device.

23. The apparatus according to claim 20, wherein said means for combining further comprises means for wrapping said mail items.

24. The apparatus according to claim 20, further comprising means for applying machine readable code to said mail items.

25. The apparatus according to claim 24, wherein said means for applying is located at said first sorter.

26. The apparatus according to claim 24, wherein means for applying is located upstream of said first sorter.

27. The apparatus according to claim 24, further comprising means for reading said machine readable code at said second sorter unit.

28. The apparatus according to claim 24, wherein said machine readable code is a bar code.

29. The apparatus according to claim 24, wherein said machine code comprises an identifier identifying at least a number of mail items sorted into at least one group at said first sorter.

30. The apparatus according to claim 29, wherein said identifier further relates to a destination address stored in data records of a database, said data records associated with said identifier such that a destination address of a mail item can be obtained from said database using said identifier to locate an appropriate data record.

31. The apparatus according to claim 20, further comprising:
means for storing destination addresses in data records of a database,
means for associating distinguishing features of mail items with said data records containing destination addresses of said mail items, and
wherein said means for sorting into end points further comprises:
means for determining said distinguishing features,
means for querying said database for data records matching said distinguishing features,
means for retrieving destination addresses from said records from said database, said data records associated with said distinguishing features, and
means for sorting mail items according to said retrieved destination addresses.

32. The apparatus according to claim 20, further comprising:
means for reading destination addresses of sorting machine incompatible mail items; and
means for transferring sorting machine incompatible mail items into sections associated with destination addresses of said incompatible mail items prior to said step of conveying said mail items to a distribution unit.

33. The apparatus according to claim 32, wherein said means for reading destination addresses of sorting machine incompatible mail items and transferring sorting machine incompatible mail items is performed automatically,

34. The apparatus according to claim 20, flier comprising means for transferring unaddressed mail item into sections associated with unaddressed mail items prior to conveying said mail items to a distribution unit

35. The apparatus according to claim 34, wherein said means for transferring unaddressed mail its is performed automatically.

36. The apparatus according to claim 20, further comprising:
means for storing destination addresses in data records of a database,
means for associating disguising features of mail items with said data records comprising destination addresses of said mail items, and
wherein said means for sorting into end points further comprises:
as for determining said distinguishing features,
means for querying said database for data records matching said distinguishing features,
means for retrieving destination addresses from said data records from said database, said data records associated with said distinguishing features, and
means for sorting mail items according to said received destination addresses.

37. The apparatus according to claim 36, wherein said second sorter machine comprises said means for sort mail items according to said retrieved destination addresses.

38. An apparatus for sorting mail items, comprising:
a destination address reader
a first sorter for sorting said mail items according to said destination address
a second sorter for sorting said mail its according to a destination address delivery scheme
a conveyor for conveying mail items sorted by delivery scheme to a distribution unit.

39. The apparatus according to claim 38, wherein said second sorter comprises a plurality of end points associated with at least one destination address.

40. The apparatus according to claim 38, further comprising:
a machine code labeler for labeling said mail items with machine readable code;
a machine code reader for reading said code; and
means for sorting said mail items according to said code.

41. The apparatus according to claim 40, wherein said first sorter comprises said labeler and said second sorter comprises said reader.

42. The apparatus according to claim 40, wherein said labeler is located upstream from said first sorter.

43. The apparatus according to claim 40, in comprising a database comprising a plurality of data records including destination addresses, said destination addresses corresponding to said code.

44. The apparatus according to claim 43, wherein said second sorter further comprises:
means for querying said database for said destination address based upon read code,
means for retrieving a destination address from a data record, said data record associated with said code, and
means for sorting said mail items based upon said retrieved destination address.

45. The apparatus according to claim 38, further comprising:
means for identifying distinguishing features about said mail items,
means for associating said features with destination addresses of said mail items,
means for storing said features and said addresses in a database, said features being associated with said addresses in said database, and
means for retrieving said destination address from said database based upon a query comprising said features.
